(19) United States
(12) Patent Application Publication
(10) Pub. No.: US 2022/0009486 A1
(43) Pub. Date: Jan. 13, 2022

(54) CALCULATION DEVICE FOR VEHICLE TRAVEL CONTROL AND TRAVEL CONTROL SYSTEM USING SAME

(71) Applicant: Mazda Motor Corporation, Hiroshima (JP)

(72) Inventors: Shinsuke SAKASHITA, Aki-gun (JP); Daisuke HORIGOME, Aki-gun (JP); Masato ISHIBASHI, Aki-gun (JP); Eiichi HOJIN, Aki-gun (JP)

(73) Assignee: Mazda Motor Corporation, Hiroshima (JP)

(21) Appl. No.: 17/485,548

(22) Filed: Sep. 27, 2021

Related U.S. Application Data
(63) Continuation of application No. PCT/JP2020/010057, filed on Mar. 9, 2020.

(30) Foreign Application Priority Data
Mar. 29, 2019 (JP) 2019-068436

(51) Int. Cl. B60W 30/14; B60W 10/20; B60W 10/18; B60W 10/04; B60W 50/00

(52) U.S. Cl. CPC B60W 30/14; B60W 10/20; B60W 2050/0031; B60W 10/04; B60W 50/00; B60W 10/18

(57) ABSTRACT

An arithmetic unit includes circuitry configured to recognize a vehicle exterior environment, set a route, determine a target motion to follow a set route, and output amounts to control traveling devices in accordance with the target motion. The circuitry is configured to calculate a steering amount for achieving the target motion, generate a control signal for controlling a steering device based on the steering amount, and directly output the control signal to the steering device. The circuitry is configured to calculate a driving force for achieving the target motion and in accordance with the steering amount, and output the drive force to a first microcomputer controlling a driving device. The circuitry is configured to calculate a braking force for achieving the target motion and in accordance with the steering amount, and output the braking force to a second microcomputer controlling a braking device.

### CROSS-REFERENCE TO RELATED APPLICATIONS

The present application claims priority to international application PCT/JP2020/010057, filed Mar. 9, 2020, and Japanese application number 2019-068436 filed in the Japanese Patent Office on Mar. 29, 2019, the entire contents of both of which being incorporated herein by reference.

### TECHNICAL FIELD

The present disclosure belongs to a technical field related to a motor vehicle cruise controller.

### BACKGROUND

There has been a known motor vehicle cruise control device which controls a plurality of vehicle-mounted units for traveling, which are mounted in a motor vehicle.

For example, Patent Document 1 discloses, as a motor vehicle cruise control device, a control system including unit controllers respectively controlling the on-board units, a domain controller controlling the unit controllers as a whole, and an integrated controller controlling the domain controllers as a whole. The control system is divided into a plurality of domains respectively corresponding to the functions of the on-board units in advance. Each of the domains is stratified into a group of the unit controllers and the domain controller. The integrated controller dominates the domain controllers.

In Patent Document 1, the unit controllers each calculate a controlled variable of an associated one of the on-board units, and each output a control signal for achieving the controlled variable to the associated on-board unit.

### CITATION LIST

### Patent Document

Patent Document 1: Japanese Unexamined Patent Publication No. 2017-61278

### SUMMARY

### Technical Problem

In recent years, development of autonomous driving systems has been promoted. In general, an autonomous driving system acquires information of an out-of-vehicle environment using a camera or any other suitable means, and calculates a route on which the motor vehicle should travel based on the acquired information of the out-of-vehicle environment. Further, in the autonomous driving system, traveling devices are controlled to follow the route to be traveled.

Here, the traveling route is followed through adjustment of physical amounts (a driving force and a steering amount) produced using the associated traveling devices. In this case, to prevent a driver from feeling uncomfortable (e.g., to prevent sudden acceleration and deceleration of a motor vehicle), the physical amounts that provide an optimum motion of the motor vehicle at every moment need to be calculated. Specifically, the processing speed for vehicle behavior control needs to be faster, and the accuracy of the vehicle behavior control needs to be increased. Meanwhile, a control path for vehicle control needs to be as simple as possible.

The present disclosure was made in view of the problems. One aspects of the present disclosure to provide a motor vehicle cruise controller that achieves both of a faster processing speed for vehicle behavior control and a simplified control path.

### SUMMARY

To solve the foregoing and other problems, the present disclosure is directed to an arithmetic unit for controlling traveling of a motor vehicle. The arithmetic unit includes: a vehicle exterior environment recognition unit configured to recognize a vehicle exterior environment based on an output from an information acquisition unit configured to acquire information of the vehicle exterior environment; a route setting unit configured to set a route to be traveled by the motor vehicle, in accordance with the vehicle exterior environment recognized by the vehicle exterior environment recognition unit; a target motion determination unit configured to determine a target motion of the motor vehicle to follow the route set by the route setting unit; a driving force calculation unit configured to calculate a target physical amount corresponding to a driving force for achieving the target motion, and output the target physical amount calculated to a microcomputer configured to control a driving device, the driving device being configured to produce a driving force; a braking force calculation unit configured to calculate another target physical amount corresponding to a braking force for achieving the target motion, and output the another target physical amount calculated to another microcomputer configured to control a braking device, the braking device being configured to produce a braking force; and a steering controller configured to calculate still another target physical amount corresponding to a steering amount for achieving the target motion, generate a control signal for controlling a steering device configured to produce a steering amount based on the still another target physical amount calculated, directly output the control signal to the steering device, and output, to the driving force calculation unit and the braking force calculation unit, information for use to perform control that allows the steering device to coordinate with the driving and braking devices.

Note that “devices” as used herein indicate devices such as actuators and sensors to be controlled while the motor vehicle is travelling.

In an autonomous driving technology, a possible vehicle controller with a simple configuration is configured such that the functions of microcomputers for controlling devices (actuators, sensors, and other components) for use in autonomous driving are incorporated in a CPU so that the arithmetic and control functions are consolidated into the arithmetic unit, which acquires information from the devices, or directly controls the devices, via an on-board communication network. However, if waiting for an instruction from the arithmetic unit transmitted via the communication network, traveling devices that require fast response (including driving devices such as an engine, braking devices, and steering devices, for example) cannot be controlled in time in some cases. To address this problem, this embodiment has the following features (1), (2), and (3). The feature (1) is that the driving and braking devices are respectively provided with the driving force calculation unit and the braking force calculation unit, which are included in the arithmetic unit to calculate the associated target physical amounts, and the calculated target physical amounts are output to the associated microcomputers respectively configured to control these devices. The feature (2) is that the steering controller configured to output the control signal for the steering device that triggers the vehicle motion is incorporated in the arithmetic unit. The feature (3) is that the steering controller outputs, to the driving force calculation unit and the braking force calculation unit, information for use to perform control that allows the driving and braking devices to coordinate with the steering device. As can be seen, as discussed in detail below, incorporating, in the arithmetic unit, the steering controller that outputs the control signal directly to the steering device that triggers the vehicle motion (e.g., an electronic power assist steering (EPAS) device) out of the traveling devices can achieve both of fast response of the traveling devices and simplification of a control path.

In addition, the steering amount of the steering device is directly controlled. This allows the processing speed to be faster than in a situation where the arithmetic unit calculates only the target physical amount, and the arithmetic result is output to, and processed by, the microcomputer for steering amount control.

The present disclosure is further directed to a motor vehicle cruise control system including the arithmetic unit. The system includes: a driving microcomputer configured to receive an output of the driving force calculation unit to control the driving device; and a braking microcomputer configured to receive an output of the braking force calculation unit to control the braking device. The driving microcomputer and the braking microcomputer are configured to be capable of communicating with each other and to share information for use to perform control that allows the driving device to coordinate with the braking device with each other.

According to this configuration, while control related to steering is incorporated in the arithmetic unit, operations of the driving and braking devices are controlled via the associated microcomputers, which coordinate with each other. Specifically, the arithmetic unit is responsible for steering which is control triggering the motor vehicle motion and which includes a relatively small number of reflective motion elements. Meanwhile, the driving and braking devices that may require reflective motions are controlled using the associated known microcomputers. This can provide optimal control adapted to various scenes and the behavior of the motor vehicle.

### ADVANTAGES

As can be seen from the description herein, according to the present disclosure, a motor vehicle cruise controller can achieve both of fast response of a traveling device and simplification of a control path.

### BRIEF DESCRIPTION OF THE DRAWINGS

FIG. 1 schematically shows a configuration of a motor vehicle which is controlled by a motor vehicle cruise control system according to an exemplary embodiment.

FIG. 2 is a schematic view illustrating a configuration of an engine.

FIG. 3 is a schematic view showing a vehicle equipped with an arithmetic unit.

FIG. 4 is a block diagram showing a control system of a motor vehicle.

FIG. 5 is a diagram of computer (including circuitry) and a network architecture of an arithmetic unit according to the embodiments

FIG. 6 is a diagram of an AI-based computer architecture according to an embodiment.

FIG. 7 is a diagram of a data extraction network according to an embodiment.

FIG. 8 is a diagram of a data analysis network according to an embodiment.

FIG. 9 is a diagram of a concatenated source feature map according to an embodiment.

### DETAILED DESCRIPTION

Exemplary embodiments will now be described in detail with reference to the drawings. Note that “traveling devices” in the present embodiment indicate devices such as actuators and sensors to be controlled while a motor vehicle 1 is traveling. Although described in detail below, examples of the “traveling devices” include devices related to traveling of the vehicle, such as a combustion injection valve, a spark plug, and a brake actuator.

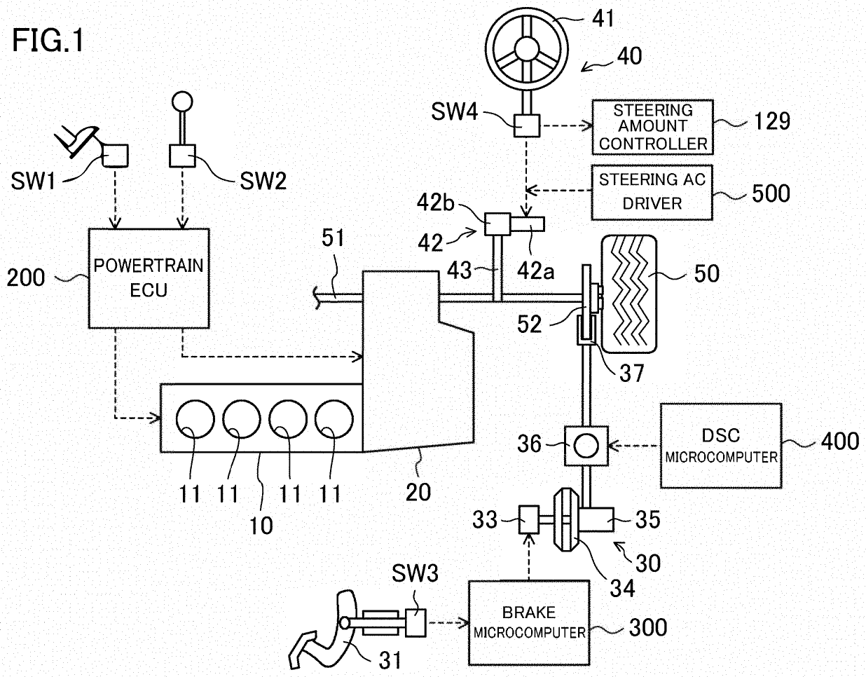

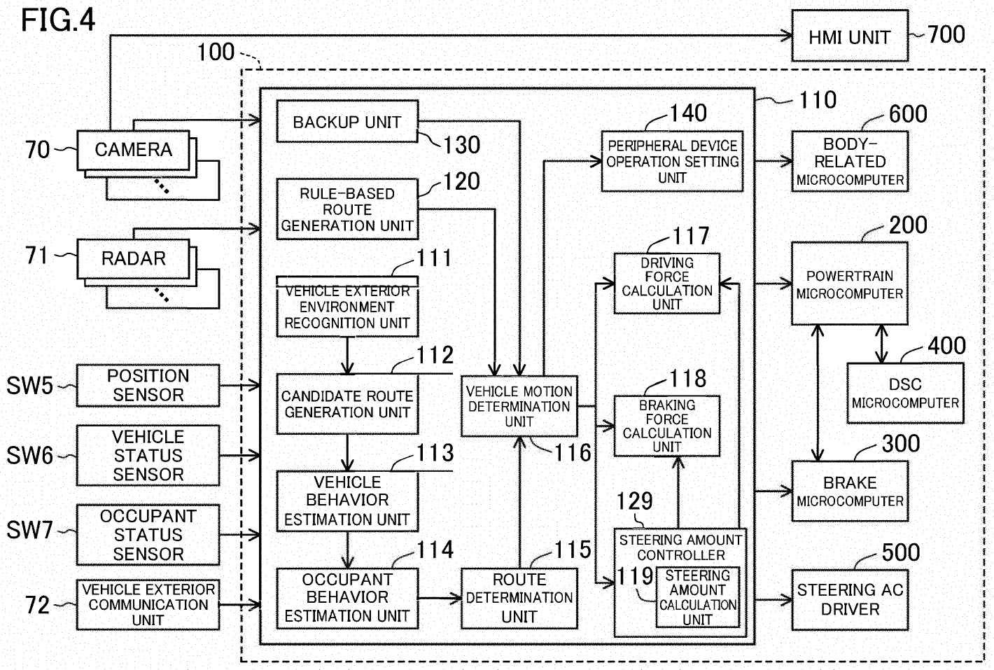

FIG. 1 schematically shows a configuration of a motor vehicle 1 which is controlled by a motor vehicle cruise control system 100 (hereinafter simply referred to as a “cruise control system 100” shown in FIG. 4) according to the present embodiment. The motor vehicle 1 is a motor vehicle that allows manual driving in which the motor vehicle 1 runs in accordance with an operation of an accelerator and any other component by a driver, assist driving in which the motor vehicle 1 runs while assisting the operation by the driver, and autonomous driving in which the motor vehicle 1 runs without the operation by the driver.

The motor vehicle 1 includes an engine 10, e.g., an internal combustion engine, as a drive source having a plurality of (four in the present embodiment) cylinders 11, a transmission 20 coupled to the engine 10, a brake device 30 that brakes rotation of front wheels 50 serving as driving wheels, and a steering system 40 that steers the front wheels 50 serving as steered wheels. Alternatively, the engine 10 may be an electrical engine that may be directly controlled.

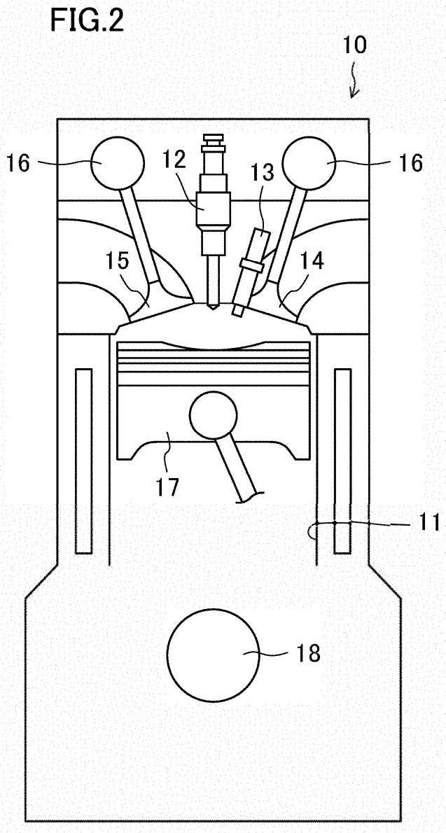

The engine 10 may be, for example, a gasoline engine. As shown in FIG. 2, each cylinder 11 of the engine 10 includes an injector 12 configured to supply fuel into the cylinder 11 and a spark plug 13 for igniting an air-fuel mixture of the fuel and intake air supplied into the cylinder 11. In addition, the engine 10 includes, for each cylinder 11, an intake valve 14, an exhaust valve 15, and a valve train mechanism 16 that adjusts opening and closing operations of the intake valve 14 and the exhaust valve 15. In addition, the engine 10 is provided with pistons 17 each configured to reciprocate in the corresponding cylinder 11 and a crankshaft 18 connected to the pistons 17 via connecting rods. Alternatively, the engine 10 may be a diesel engine. In a case of adopting a diesel engine as the engine 10, the spark plug 13 does not have to be provided. The injector 12, the spark plug 13, and the valve train mechanism 16 are examples of devices related to a powertrain (i.e., drive devices).

The transmission 20 (for internal combustion engines) is, for example, a stepped automatic transmission. The transmission 20 is arranged on one side of the engine 10 along the cylinder bank. The transmission 20 includes an input shaft coupled to the crankshaft 18 of the engine 10, and an output shaft coupled to the input shaft via a plurality of reduction gears. The output shaft is connected to an axle 51 of the front wheels 50. The rotation of the crankshaft 18 is changed by the transmission 20 and transmitted to the front wheels 50. The transmission 20 is an example of the devices related to the powertrain (i.e., drive devices).

The engine 10 and the transmission 20 are powertrain devices that generate a driving force for causing the motor vehicle 1 to travel. The operations of the engine 10 and the transmission 20 are controlled by a powertrain electric control unit (ECU) 200 (equivalent to a driving microcomputer). For example, during the manual driving of the motor vehicle 1, the powertrain ECU 200 controls an injection amount from and a timing for fuel injection by the injector 12, a timing for ignition by the spark plug 13, timings for opening the intake and exhaust valves 14 and 15 by the valve train mechanism 16, and the duration of opening these valves, based on values such as a detected value of an accelerator position sensor SW1 that detects an accelerator position and any other sensor, which correspond to an operation amount of the accelerator pedal by the driver. In addition, during the manual driving of the motor vehicle 1, the powertrain ECU 200 adjusts the gear position of the transmission 20 based on a required driving force calculated from a detection result of a shift sensor SW2 that detects an operation of the shift lever by the driver and the accelerator position. In addition, during the assist driving or the autonomous driving of the motor vehicle 1, the powertrain ECU 200 basically calculates a controlled variable for each drive device (injector 12 and any other component in this case) and outputs a control signal to the corresponding drive device, so as to achieve a target driving force calculated by an arithmetic unit 110 described hereinafter. The powertrain ECU 200 is an example of a device controller.

The brake device 30 includes a brake pedal 31, a brake actuator 33, a booster 34 connected to the brake actuator 33, a master cylinder 35 connected to the booster 34, anti-braking system (ABS) devices 36 that adjust the braking force, and brake pads 37 that actually brake the rotation of the front wheels 50. To the axle 51 of the front wheels 50, disc rotors 52 are provided. The brake device 30 is an electric brake, and actuates the brake actuator 33 in accordance with the operation amount of the brake pedal 31 detected by the brake sensor SW3, to actuate the brake pads 37 via the booster 34 and the master cylinder 35. The brake device 30 clamps the disc rotor 52 by the brake pads 37, to brake the rotation of each front wheel 50 by the frictional force generated between the brake pads 37 and the disc rotor 52. The brake actuator 33 and the ABS devices 36 are examples of devices related to the brake (i.e., braking devices).

The actuation of the brake device 30 is controlled by a brake microcomputer 300 (a braking microcomputer) and a DSC microcomputer 400. For example, during the manual driving of the motor vehicle 1, the brake microcomputer 300 controls the operation amount of the brake actuator 33 based on a detected value from the brake sensor SW3 that detects the operation amount of the brake pedal 31 by the driver, and any other sensor. In addition, the DSC microcomputer 400 controls actuation of the ABS device 36 to add a braking force to the front wheels 50, irrespective of an operation of the brake pedal 31 by the driver. In addition, during the assist driving or the autonomous driving of the motor vehicle 1, the brake microcomputer 300 calculates a controlled variable for each braking device (brake actuator 33 in this case) and outputs a control signal to the corresponding braking device, so as to achieve a target controlling force calculated by the arithmetic unit 110 described hereinafter. The brake microcomputer 300 and the DSC microcomputer 400 are each an example of the device controller. Note that the brake microcomputer 300 and the DSC microcomputer 400 may be configured by a single microcomputer.

The steering system 40 includes a steering wheel 41 to be operated by the driver, an electronic power assist steering (EPAS) device 42 configured to assist the driver in a steering operation, and a pinion shaft 43 coupled to the EPAS device 42. The EPAS device 42 includes an electric motor 42a, and a deceleration device 42b configured to reduce the driving force from the electric motor 42a and transmit the force to the pinion shaft 43. The steering system 40 actuates the EPAS device 42 in accordance with the operation amount of the steering wheel 41, so as to rotate the pinion shaft 43, thereby controlling the front wheels 50. The pinion shaft 43 is coupled to the front wheels 50 through a rack bar, and the rotation of the pinion shaft 43 is transmitted to the front wheels via the rack bar. The operation amount of the steering wheel 41 is detected by a steering angle sensor SW4 and sent to a steering controller 129 of the arithmetic unit 110. The EPAS device 42 is an example of steering related devices, i.e., steering devices.

During the manual driving of the motor vehicle 1, the steering system 40 is configured such that the operation amount of the electric motor 42a is controlled based on the operation amount of the steering wheel 41. In addition, during the assist driving or the autonomous driving of the motor vehicle 1, a control signal for controlling the steering devices (EPAS device 42 in this case) is output from the steering controller 129 of the arithmetic unit 110 described below to a steering device driver 500. Then, the steering system 40 is configured such that the operation amount of the electric motor 42a is controlled based on the control signal of the steering device driver 500.

Although will be described later in detail, in the present embodiment, the powertrain ECU 200 and the brake microcomputer 300 are configured to be capable of communicating with each other. In the following description, the powertrain ECU 200 and the brake microcomputer 300 may be simply referred to as the “device controllers.”

The cruise control system 100 of the present embodiment includes the arithmetic unit 110 that determines motions of the motor vehicle 1 to calculate a route to be traveled by the motor vehicle 1 and follow the route, so as to enable the assist driving and the autonomous driving. The respective “units” are configured as computing hardware of the arithmetic unit 110, which may be programmed with software code to perform described functions. The arithmetic unit 110 is a microprocessor configured by one or more chips, and includes a CPU, a memory, and any other component.

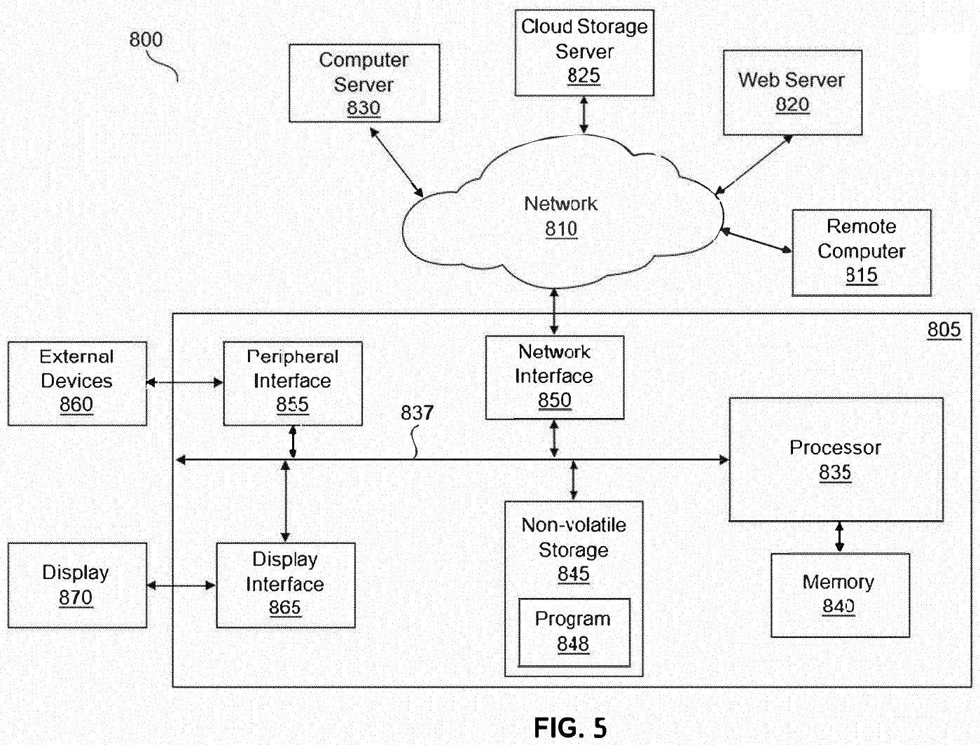

The cruise control system 100 is computer hardware (circuitry) that executes software, and specifically includes a processor including a CPU, and a non-transitory memory that stores executable code including a plurality of modules, for example, as will be discussed in more detail with respect to FIG. 5. The term “cruise control device” is used interchangeably herein with “cruise control circuitry”. It should be understood that regardless of whether the term “system” or “circuitry” is used, the system/circuitry can be dedicated circuitry, such as an application specific integrated circuit (ASIC), or programmable logic array (PLA), or processor circuitry that executes computer readable instructions to that cause the processor circuitry to perform certain functions by executing processing steps within the processing circuitry. The cruise control circuitry includes certain “units” which should be construed as structural circuit(s), whether application specific or programmable, that execute certain operations as part of the cruise control circuitry.

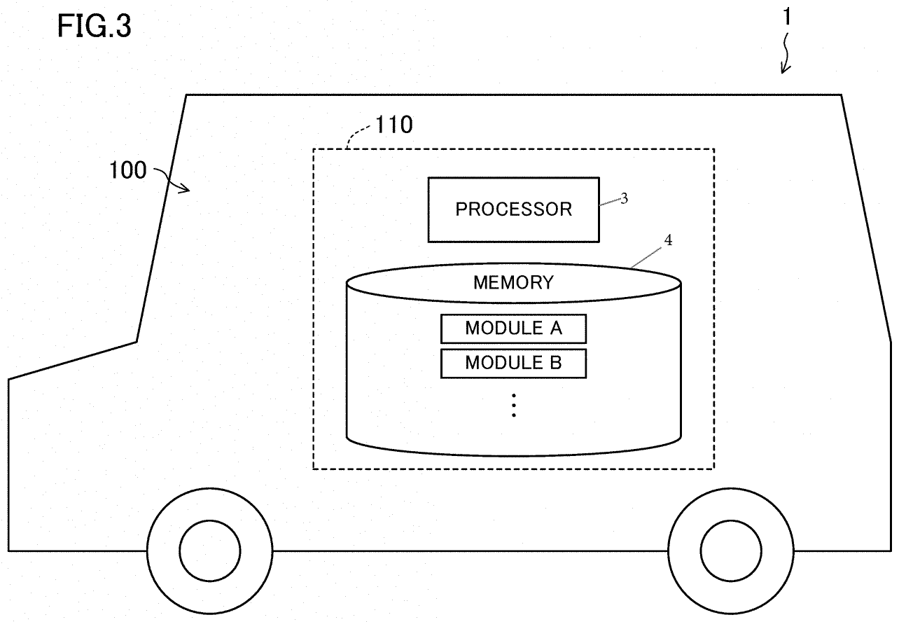

In the exemplary configuration of FIG. 3, the arithmetic unit 110 includes a processor 3 and a memory 4. The memory 3 stores modules which are each a software program executable by the processor. The functions of units of the arithmetic unit 110 shown in FIG. 4 are achieved, for example, by the processor 3 executing the modules stored in the memory. In addition, the memory 4 stores data of a model for use in the arithmetic unit 110. Note that a plurality of processors and a plurality of memories may be provided.

As shown in FIG. 4, the arithmetic unit 110 determines a target motion of the motor vehicle 1 based on outputs from a plurality of sensors and any other component, and controls actuation of the devices. Note that FIG. 4 shows a configuration to exert functions according to the present embodiment (route generating function described later), and does not necessarily show all the functions implemented in the arithmetic unit 110.

The sensors and any other component that output information to the arithmetic unit 110 include a plurality of cameras 70 provided to the body and any other part of the motor vehicle 1 and configured to take images of the environment outside the vehicle (hereinafter, vehicle exterior environment); a plurality of radars 71 provided to the body and any other part of the motor vehicle 1 and configured to detect an object and the like outside the vehicle; a position sensor SW5 configured to detect the position of the motor vehicle 1 (motor vehicle position information) by using a global positioning system (GPS); a vehicle status sensor SW6 configured to acquire a status of the motor vehicle 1, which includes outputs from sensors that detect the behavior of the motor vehicle, such as a vehicle speed sensor, an acceleration sensor, and a yaw rate sensor; and an occupant status sensor SW7 including an in-vehicle camera and the like and configured to acquire a status of an occupant in the motor vehicle 1. In addition, the arithmetic unit 110 receives communication information from another motor vehicle positioned around the subject vehicle or traffic information from a navigation system, which is received by a vehicle exterior communication unit 72.

The cameras 70 are arranged to image the surroundings of the motor vehicle 1 at 360° in the horizontal direction. Each camera 70 captures optical images showing the environment outside the vehicle to generate image data. Each camera 70 then outputs the image data generated to the arithmetic unit 110. The cameras 70 are examples of an information acquisition unit that acquires information of the vehicle exterior environment.

The image data acquired by each camera 70 is also input to a human machine interface (HMI) unit 600, in addition to the arithmetic unit 110. The HMI unit 600 displays information based on the image data acquired, on a display device or the like in the vehicle.

The radars 71 are arranged so that the detection range covers 360° of the motor vehicle 1 in the horizontal direction, similarly to the cameras 70. The type of the radars 71 is not particularly limited. For example, a millimeter wave radar or an infrared radar can be adopted. The radars 71 are examples of an information acquisition unit that acquires information of the vehicle exterior environment.

During the assist driving or the autonomous driving, the arithmetic unit 110 sets a traveling route of the motor vehicle 1 and sets a target motion of the motor vehicle 1 so as to follow the traveling route of the motor vehicle 1. The arithmetic unit 110 includes a vehicle exterior environment recognition unit 111 that recognizes the vehicle exterior environment based on outputs from the cameras 70 and the like to set a target motion of the motor vehicle 1, a candidate route generation unit 112 that calculates one or more candidate routes travelable by the motor vehicle 1 in accordance with the vehicle exterior environment recognized by the vehicle exterior environment recognition unit 111, a vehicle behavior estimation unit 113 that estimates a behavior of the motor vehicle 1 based on an output from the vehicle status sensor SW6, an occupant behavior estimation unit 114 that estimates a behavior of an occupant of the motor vehicle 1 based on an output from the occupant status sensor SW7, a route determination unit 115 that determines a route to be traveled by the motor vehicle 1, and a vehicle motion determination unit 116 that determines a target motion of the motor vehicle 1 for following the route determined by the route determination unit 115.

The arithmetic unit 110 further includes a driving force calculation unit 117 that calculates a target physical amount corresponding to a driving force for achieving the target motion determined by the vehicle motion determination unit 116, a braking force calculation unit 118 that calculates a target physical amount corresponding to a braking force, and the steering controller 129. The steering controller 129 includes a steering amount calculation unit 119 that calculates a target physical amount corresponding to a steering amount for achieving the target motion determined by the vehicle motion determination unit 116, generates a control signal for controlling the steering devices, and directly outputs the generated control signal to the steering device driver 500. The steering devices as used herein conceptually include, in addition to steering-related actuators including the EPAS device 42, components for directly driving such actuators (e.g., the steering device driver 500).

The candidate route generation unit 112, the vehicle behavior estimation unit 113, the occupant behavior estimation unit 114, and the route determination unit 115 constitute a route setting unit configured to set the route to be traveled by the motor vehicle 1, in accordance with the vehicle exterior environment recognized by the vehicle exterior environment recognition unit 111.

In addition, as safety functions, the arithmetic unit 110 includes a rule-based route generation unit 120 configured to recognize an object outside the vehicle according to a predetermined rule and generate a traveling route that avoids the object, and a backup unit 130 configured to generate a traveling route that guides the motor vehicle 1 to a safety area such as a road shoulder.

<Vehicle Exterior Environment Recognition Unit>

The vehicle exterior environment recognition unit 111 (as further described in U.S. application Ser. No. 17/120,292 filed Dec. 14, 2020, and U.S. application Ser. No. 17/160,426 filed Jan. 28, 2021, the entire contents of each of which being incorporated herein by reference) receives outputs from the cameras 70 and the radars 71 which are mounted on the motor vehicle 1 and recognizes the vehicle exterior environment. The recognized vehicle exterior environment includes at least a road and an obstacle. Here, it is assumed that the vehicle exterior environment recognition unit 111 estimates the motor vehicle environment including the road and the obstacle by comparing the 3-dimensional information of the surroundings of the motor vehicle 1 with a vehicle external environment model, based on data from the cameras 70 and the radars 71. The vehicle external environment model is, for example, a learned model generated by deep learning, and allows recognition of a road, an obstacle, and the like with respect to 3-dimensional information of the surroundings of the motor vehicle 1.

For example, the vehicle exterior environment recognition unit 111 identifies a free space, that is, an area without an object, by processing images captured by the cameras 70. In this image processing, for example, a learned model generated by deep learning is used. Then, a 2-dimensional map representing the free space is generated. In addition, the vehicle exterior environment recognition unit 111 acquires information on objects around the motor vehicle 1 from the outputs of the radars 71. This information is positioning information containing the position, the speed, and any other element of the object. Then, the vehicle exterior environment recognition unit 111 combines the 2-dimensional map thus generated with the positioning information of the object to generate a 3-dimensional map representing the surroundings of the motor vehicle 1. This process uses information of the installation positions of and the shooting directions of the cameras 70, and information of the installation positions of and the transmission direction of the radars 71. The vehicle exterior environment recognition unit 111 then compares the generated 3-dimensional map with the vehicle external environment model to estimate the motor vehicle environment including the road and the obstacle. Note that the deep learning uses a multilayer neural network (deep neutral network (DNN)). An example of the multilayer neural network is a convolutional neural network (CNN).

<Candidate Route Generation Unit>

The candidate route generation unit 112 (an example of which is further described in more detail in U.S. application Ser. No. 17/161,691, filed 29 Jan. 2021, U.S. application Ser. No. 17/161,686, filed 29 Jan. 2021, and U.S. application Ser. No. 17/161,683, the entire contents of each of which being incorporated herein by reference) generates candidate routes that can be traveled by the motor vehicle 1, based on an output from the vehicle exterior environment recognition unit 111, an output from the position sensor SW5, and information transmitted from the vehicle exterior communication unit 72. For example, the candidate route generation unit 112 generates a traveling route that avoids the obstacle recognized by the vehicle exterior environment recognition unit 111, on the road recognized by the vehicle exterior environment recognition unit 111. The output from the vehicle exterior environment recognition unit 111 includes, for example, traveling road information related to a traveling road on which the motor vehicle 1 travels. The traveling road information includes information related to the shape of the traveling road itself and information related to objects on the traveling road. The information related to the shape of the traveling road includes the shape of the traveling road (whether it is straight or curved, and the curvature), the width of the traveling road, the number of lanes, and the width of each lane. The information related to the objects includes the positions and speeds of the objects relative to the motor vehicle, and the attributes (e.g., the type or the moving directions) of the objects. Examples of the object types include a motor vehicle, a pedestrian, a road, and a section line.

Here, it is assumed that the candidate route generation unit 112 calculates a plurality of candidate routes by means of a state lattice method, and selects one or more candidate routes from among these candidate routes based on a route cost of each candidate route. However, the routes may be calculated by means of a different method.

The candidate route generation unit 112 sets a virtual grid area on the traveling road based on the traveling road information. The grid area has a plurality of grid points. Each grid point identifies the position on the traveling road. The candidate route generation unit 112 sets a predetermined grid point as a destination. Then, a plurality of candidate routes are calculated by a route search involving a plurality of grid points in the grid area. In the state lattice method, a route branches from a certain grid point to random grid points ahead in the traveling direction of the motor vehicle. Therefore, each candidate route is set so as to sequentially pass a plurality of grid points. Each candidate route includes time information indicating a time of passing each grid point, speed information related to the speed, acceleration, and any other element at each grid point, and information related to other motor vehicle motions.

The candidate route generation unit 112 selects one or more traveling routes from the plurality of candidate routes based on the route cost. The route cost herein includes, for example, the lane-centering degree, the acceleration of the motor vehicle, the steering angle, and the possibility of collision. Note that, when the candidate route generation unit 112 selects a plurality of traveling routes, the route determination unit 115 selects one of the traveling routes.

<Vehicle Behavior Estimation Unit>

The vehicle behavior estimation unit 113 (as further described in PCT application WO2020184297A1 filed Mar. 3, 2020, the entire contents of which being incorporated herein by reference), measures a status of the motor vehicle, from the outputs of sensors which detect the behavior of the motor vehicle, such as a vehicle speed sensor, an acceleration sensor, and a yaw rate sensor. The vehicle behavior estimation unit 113 generates a six-degrees-of-freedom (i.e., 6DoF) model of the vehicle indicating the behavior of the motor vehicle (as further described in more detail in U.S. application Ser. No. 17/159,175, filed Jan. 27, 2021, the entire contents of which being incorporated herein by reference).

Here, the 6DoF model of the vehicle is obtained by modeling acceleration along three axes, namely, in the “forward/backward (surge)”, “left/right (sway)”, and “up/down (heave)” directions of the traveling motor vehicle, and the angular velocity along the three axes, namely, “pitch”, “roll”, and “yaw”. That is, the 6DoF model of the vehicle is a numerical model not grasping the motor vehicle motion only on the plane (the forward/backward and left/right directions (i.e., the movement along the X-Y plane) and the yawing (along the Z-axis)) according to the classical motor vehicle motion engineering but reproducing the behavior of the motor vehicle using six axes in total. The motor vehicle motions along the six axes further include the pitching (along the Y-axis), rolling (along the X-axis) and the movement along the Z-axis (i.e., the up/down motion) of the vehicle body mounted on the four wheels with the suspension interposed therebetween.

The vehicle behavior estimation unit 113 applies the 6DoF model of the vehicle to the traveling route generated by the candidate route generation unit 112 to estimate the behavior of the motor vehicle 1 when following the traveling route.

<Occupant Behavior Estimation Unit>

The occupant behavior estimation unit 114 specifically estimates the driver's health condition and emotion from a detection result from the occupant status sensor SW7. Examples of the health conditions include good condition, slightly tired condition, poor condition, and less conscious condition. Examples of the emotions include happy, normal, bored, annoyed, uncomfortable, and the like. Details of such estimation are disclosed in U.S. Pat. No. 10,576,989, which entire contents of which is hereby incorporated by reference.

For example, the occupant behavior estimation unit 114 extracts a face image of the driver from an image captured by a camera installed inside the vehicle cabin, and identifies the driver. The extracted face image and information of the identified driver are provided as inputs to a human model. The human model is, for example, a learned model generated by deep learning, and outputs the health condition and the emotion of each person who may be the driver, from the face image. The occupant behavior estimation unit 114 outputs the health condition and the emotion of the driver output by the human model.

In addition, in a case of adopting a bio-information sensor, such as a skin temperature sensor, a heartbeat sensor, a blood flow sensor, and a perspiration sensor, as the occupant status sensor SW7 for acquiring information of the driver, the occupant behavior estimation unit 114 measures the bio-information of the driver from the output from the bio-information sensor. In this case, the human model uses the bio-information as the input, and outputs the health condition and the emotion of each person who may be the driver. The occupant behavior estimation unit 114 outputs the health condition and the emotion of the driver output by the human model.

In addition, as the human model, a model that estimates an emotion of a human in response to the behavior of the motor vehicle 1 may be used for each person who may be the driver. In this case, the model may be constructed by managing, in time sequence, the outputs of the vehicle behavior estimation unit 113, the bio-information of the driver, and the estimated emotional conditions. This model allows, for example, the relationship between changes in the driver's emotion (the degree of wakefulness) and the behavior of the motor vehicle to be predicted.

The occupant behavior estimation unit 114 may include a human body model as the human model. The human body model specifies, for example, the weight of the head (e.g., 5 kg) and the strength of the muscles around the neck supporting against G-forces in the front, back, left, and right directions. The human body model outputs a predicted physical condition and subjective viewpoint of the occupant, when a motion (acceleration G-force or jerk) of the vehicle body is input. Examples of the physical condition of the occupant include comfortable/moderate/uncomfortable conditions, and examples of the subjective viewpoint include whether a certain event is unexpected or predictable. For example, a vehicle behavior that causes the head to lean backward even slightly is uncomfortable for an occupant. Therefore, a traveling route that causes the head to lean backward can be avoided by referring to the human body model. On the other hand, a vehicle behavior that causes the head of the occupant to lean forward in a bowing manner does not immediately lead to discomfort. This is because the occupant is easily able to resist such a force. Therefore, such a traveling route that causes the head to lean forward may be selected. Alternatively, referring to the human body model allows a target motion to be determined so that, for example, the head of the occupant does not swing, or to be dynamically determined so that the occupant is active.

The occupant behavior estimation unit 114 applies a human model to the vehicle behavior estimated by the vehicle behavior estimation unit 113 to estimate a change in the health conditions or the feeling of the current driver with respect to the vehicle behavior.

<Route Determination Unit>

The route determination unit 115 determines the route along which the motor vehicle 1 is to travel, based on an output from the occupant behavior estimation unit 114. If the number of routes generated by the candidate route generation unit 112 is one, the route determination unit 115 determines that route as the route to be traveled by the motor vehicle 1. If the candidate route generation unit 112 generates a plurality of routes, a route that an occupant (in particular, the driver) feels most comfortable with, that is, a route that the driver does not perceive as a redundant route, such as a route too cautiously avoiding an obstacle, is selected out of the plurality of candidate routes, in consideration of an output from the occupant behavior estimation unit 114.

<Rule-Based Route Generation Unit>

The rule-based route generation unit 120 recognizes an object outside the vehicle in accordance with a predetermined rule based on outputs from the cameras 70 and radars 71, without using deep learning, and generates a traveling route that avoids such an object. Similarly to the candidate route generation unit 112, it is assumed that the rule-based route generation unit 120 also calculates a plurality of candidate routes by means of the state lattice method, and selects one or more candidate routes from among these candidate routes based on a route cost of each candidate route. Further explanation of how a route cost may be determined is described in U.S. patent application Ser. No. 16/739,144, filed on Jan. 10, 2020, the entire contents of which is incorporated herein by reference. In the rule-based route generation unit 120, the route cost is calculated based on, for example, a rule of preventing the vehicle from entering an area within several meters from the object. Other techniques may be used for calculation of the route also in this rule-based route generation unit 120.

Information of a route generated by the rule-based route generation unit 120 is input to the vehicle motion determination unit 116.

<Backup Unit>

The backup unit 130 generates a traveling route that guides the motor vehicle 1 to a safe area such as the road shoulder, based on outputs from the cameras 70 and radars 71, in an occasion of failure of a sensor or any other component, or when the occupant is not feeling well. For example, from the information given by the position sensor SW5, the backup unit 130 sets a safety area in which the motor vehicle 1 can be stopped in case of emergency, and generates a traveling route to reach the safety area. Similarly to the candidate route generation unit 112, it is assumed that the backup unit 130 also calculates a plurality of candidate routes by means of the state lattice method, and selects one or more candidate routes from among these candidate routes based on a route cost of each candidate route. Another technique may be used for calculation of the route also in this backup unit 130.

Information of a route generated by the backup unit 130 is input to the vehicle motion determination unit 116.

<Vehicle Motion Determination Unit>

The vehicle motion determination unit 116 (as further described in more detail in U.S. application Ser. No. 17/159,178, filed Jan. 27, 2021, the entire contents of which being incorporated herein by reference), determines a target motion on a traveling route determined by the route determination unit 115. The target motion means steering and acceleration/deceleration to follow the traveling route. In addition, with reference to the 6DoF model of the vehicle, the target motion determination unit 115 calculates the motion of the vehicle body on the traveling route selected by the route determination unit 115.

The vehicle motion determination unit 116 determines the target motion to follow the traveling route generated by the rule-based route generation unit 120.

The vehicle motion determination unit 116 determines the target motion to follow the traveling route generated by the backup unit 130.

When the traveling route determined by the route determination unit 115 significantly deviates from a traveling route generated by the rule-based route generation unit 120, the vehicle motion determination unit 116 selects the traveling route generated by the rule-based route generation unit 120 as the route to be traveled by the motor vehicle 1.

In an occasion of failure of sensors or any other component (in particular, cameras 70 or radars 71) or in a case where the occupant is not feeling well, the vehicle motion determination unit 116 selects the traveling route generated by the backup unit 130 as the route to be traveled by the motor vehicle 1.

<Physical Amount Calculation Unit>

A physical amount calculation unit includes a driving force calculation unit 117 and a braking force calculation unit 118. To achieve the target motion, the driving force calculation unit 117 calculates a target driving force to be generated by the powertrain devices (and the transmission 20). To achieve the target motion, the braking force calculation unit 118 calculates a target braking force to be generated by the brake device 30.

<Steering Controller>

The steering controller 129 includes the steering amount calculation unit 119 that calculates a target steering amount to be generated by the steering system 40 to achieve the target motion, and generates a control signal for controlling the steering devices based on the target steering amount calculated by the steering amount calculation unit 119. The signal output from the steering controller 129 is input to the steering device driver 500, which drives the steering devices (e.g., the EPAS device 42).

The steering controller 129 is configured to output, to the driving force calculation unit 117 and the braking force calculation unit 118, information for control to allow the “steering devices” to coordinate with the “drive devices and braking devices.” Specifically, the steering controller 129 shares information related to the physical amounts calculated by the steering amount calculation unit 119 and information on how the steering controller controls the steering devices with the driving force calculation unit 117 and the braking force calculation unit 118, and is configured to be capable of calculating associated target physical amounts so as to be capable of executing control to allow traveling devices to cooperate with one another.

Thus, for example, while a road surface is slippery, so-called traction control required to reduce the rotation of the wheels to prevent the wheels from spinning can be suitably accommodated. Specifically, to reduce spinning of the wheels, the output of the powertrain may be reduced, or the braking force of the brake device 30 may be used. However, if the driving force calculation unit 117 and the braking force calculation unit 118 respectively set the driving force to be generated by the powertrain and the braking force to be generated by the brake device 30 to associated optimum values, the running performance of the motor vehicle can be stabilized.

When the motor vehicle 1 is to corner, the driving force calculation unit 117 calculates a target driving force based on the driving state of the motor vehicle (the driving state determined by the vehicle motion determination unit 116), calculates the amount of the driving force reduced in response to the target steering amount calculated by the steering amount calculation unit 119, and then calculates a final target driving force of the motor vehicle in response to the target driving force and the amount of the driving force reduced. This allows a deceleration corresponding to the target steering amount to be produced. As a result, rolling and pitching that causes a front portion of the motor vehicle 1 to move downward are induced in synchronization with each other to give rise to diagonal rolling. Giving rise to the diagonal rolling increases the load applied to the outer front wheel 50. This allows the motor vehicle 1 to corner with small steering angle, and can reduce the rolling resistance to the motor vehicle 1.

In addition, if, for example, when the steering angle is changed during cornering, the road surface condition recognized by the vehicle exterior environment recognition unit 111 is assumed to be slippery (e.g., in the event of rain), understeer, i.e., a situation where a driving line curves outward, is assumed to occur. Thus, control can be performed so that braking the inner wheels while reducing the output of the engine 10 reduces skidding of the front wheels. Conversely, if the road surface condition recognized by the vehicle exterior environment recognition unit 111 is likely to allow the grip of tires on the road surface to be stronger than expected (e.g., if the road surface is very new in fine weather), oversteer, i.e., a situation where the driving line curves inward, is assumed to occur. Thus, control can be performed so that braking the outer wheels reduces skidding of rear wheels.

<Peripheral Device Operation Setting Unit>

A peripheral device operation setting unit 140 sets operations of body-related devices of the motor vehicle 1, such as lamps and doors, based on outputs from the vehicle motion determination unit 116. The peripheral device operation setting unit 140 determines, for example, the directions of lamps, while the motor vehicle 1 follows the traveling route determined by the route determination unit 115. In addition, for example, at a time of guiding the motor vehicle 1 to the safety area set by the backup unit 130, the peripheral device operation setting unit 140 sets operations so that the hazard lamp is turned on and the doors are unlocked after the motor vehicle 1 reaches the safety area.

<Output Destination of Arithmetic Unit>

An arithmetic result of the arithmetic unit 110 is output to the powertrain ECU 200, the brake microcomputer 300, the steering device driver 500, and a body-related microcomputer 600. Specifically, information related to the target driving force calculated by the driving force calculation unit 117 is input to the powertrain ECU 200. Information related to the target braking force calculated by the braking force calculation unit 118 is input to the brake microcomputer 300. A control signal from the steering controller 129 is input to the steering device driver 500. Information related to the operations of the body-related devices set by the peripheral device operation setting unit 140 is input to the body-related microcomputer 600.

As described hereinabove, the powertrain ECU 200 calculates fuel injection timing for the injector 12 and ignition timing for the spark plug 13 so as to achieve the target driving force, and outputs control signals to these relevant traveling devices. The brake microcomputer 300 calculates a controlled variable of the brake actuator 33 so as to achieve the target driving force, and outputs a control signal to the brake actuator 33. The steering device driver 500 drives the EPAS device 42 based on the control signal from the steering controller 129.

As described hereinabove, in the present embodiment, the arithmetic unit 110 calculates the target physical amounts to be output from the drive devices and the braking devices out of the drive devices, the braking devices, and the steering devices, and the controlled variables of these devices are calculated by the powertrain ECU 200 and the brake microcomputer 300.

As can be seen, the arithmetic unit 110 calculates rough target physical amounts corresponding to the exterior environment, and while final control performed by the powertrain ECU 200 and the brake microcomputer 300 achieves autonomous driving corresponding to the exterior environment, control requiring quick response to the behavior of the vehicle can be performed by the powertrain ECU 200 and the brake microcomputer 300. Thus, while a target motion of the whole motor vehicle that may be optimum at every moment is determined, and the associated microcomputer is instructed to achieve the target motion, a process requiring quick response can be performed using the microcomputer's own judgment. For example, in situations such as a situation where the arithmetic unit 110 is disposed in the vehicle cabin, the trunk space, or any other space, and while the powertrain ECU 200 is disposed near devices that are driven by the powertrain ECU 200, the brake microcomputer 300 is disposed near devices that are driven by the brake microcomputer 300, the communication rate between the arithmetic unit 110 and each of the powertrain ECU 200 and the brake microcomputer 300 may form a bottleneck in the quick response. To address this problem, the configuration described herein can provide control that does not depend on the communication rate between the arithmetic unit 110 and each of the powertrain ECU 200 and the brake microcomputer 300, i.e., both of optimal control and quick response control.

Furthermore, the steering controller 129 of the arithmetic unit 110 is configured to calculate the target physical amounts to be output from the steering devices out of the drive devices, the braking devices, and the steering devices, generate a control signal for achieving the target physical amounts, and directly control the steering device driver 500.

As can be seen, the control related to the steering that triggers a motion of the motor vehicle is incorporated into the arithmetic unit 110, which generates the control signal for controlling the steering devices as well, and the target physical amounts and control information related to the control are output to the driving force calculation unit 117 and the braking force calculation unit 118. This can increase the control accuracy of each of the actuators.

In addition, the steering controller 129 is configured to directly control the steering devices. This allows the processing speed to be faster than in a situation where the arithmetic unit 110 calculates only the target physical amounts, and the arithmetic results are output to, and processed by, a microcomputer for steering amount control.

Note that the response speed of the steering devices required for quick response control is typically lower than the response speeds of the driving devices and the braking devices. Thus, even in situations such as a situation where the arithmetic unit 110 is apart from the steering devices, as long as the communication rate between the arithmetic unit 110 and the steering devices is adapted to vehicle use under present or future conditions, the configuration of this application can also adequately accommodate quick response of the steering devices.

<Other Control Manners>

The driving force calculation unit 117, the braking force calculation unit 118, and the steering controller 129 may be configured to modify the target driving force and other associated elements in accordance with the status of the driver of the motor vehicle 1, during the assist driving of the motor vehicle 1. For example, when the driver enjoys driving (when the driver feels “happy”), the target driving force and other associated elements may be reduced to make driving as close as possible to manual driving. On the other hand, when the driver is not feeling well, the target driving force and other associated elements may be increased to make the driving as close as possible to the autonomous driving.

### Other Embodiments

The present disclosure is not limited to the embodiments described above, and may be modified within the scope of the claims.

For example, in the above-described embodiments, the route determination unit 115 determines the route to be travelled by the motor vehicle 1. However, the present disclosure is not limited to this, and the route determination unit 115 may be omitted. In this case, the vehicle motion determination unit 116 may determine the route to be traveled by the motor vehicle 1. That is, the vehicle motion determination unit 116 may serve as a part of the route setting unit as well as a target motion determination unit.

FIG. 5 illustrates a block diagram of a computer that may implement the various embodiments described herein.

The present disclosure may be embodied as a system, a method, and/or a computer program product. The computer program product may include a computer readable storage medium on which computer readable program instructions are recorded that may cause one or more processors to carry out aspects of the embodiment.

The computer readable storage medium may be a tangible device that can store instructions for use by an instruction execution device (processor). The computer readable storage medium may be, for example, but is not limited to, an electronic storage device, a magnetic storage device, an optical storage device, an electromagnetic storage device, a semiconductor storage device, or any appropriate combination of these devices. A non-exhaustive list of more specific examples of the computer readable storage medium includes each of the following (and appropriate combinations): flexible disk, hard disk, solid-state drive (SSD), random access memory (RAM), read-only memory (ROM), erasable programmable read-only memory (EPROM or Flash), static random access memory (SRAM), compact disc (CD or CD-ROM), digital versatile disk (DVD) and memory card or stick. A computer readable storage medium, as used in this disclosure, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described in this disclosure can be downloaded to an appropriate computing or processing device from a computer readable storage medium or to an external computer or external storage device via a global network (i.e., the Internet), a local area network, a wide area network and/or a wireless network. The network may include copper transmission wires, optical communication fibers, wireless transmission, routers, firewalls, switches, gateway computers and/or edge servers. A network adapter card or network interface in each computing or processing device may receive computer readable program instructions from the network and forward the computer readable program instructions for storage in a computer readable storage medium within the computing or processing device.

Computer readable program instructions for carrying out operations of the present disclosure may include machine language instructions and/or microcode, which may be compiled or interpreted from source code written in any combination of one or more programming languages, including assembly language, Basic, Fortran, Java, Python, R, C, C++, C # or similar programming languages. The computer readable program instructions may execute entirely on a user's personal computer, notebook computer, tablet, or smartphone, entirely on a remote computer or computer server, or any combination of these computing devices. The remote computer or computer server may be connected to the user's device or devices through a computer network, including a local area network or a wide area network, or a global network (i.e., the Internet). In some embodiments, electronic circuitry including, for example, programmable logic circuitry, field-programmable gate arrays (FPGA), or programmable logic arrays (PLA) may execute the computer readable program instructions by using information from the computer readable program instructions to configure or customize the electronic circuitry, in order to perform aspects of the present disclosure.

Aspects of the present disclosure are described herein with reference to flow diagrams and block diagrams of methods, apparatus (systems), and computer program products according to embodiments of the disclosure. It will be understood by those skilled in the art that each block of the flow diagrams and block diagrams, and combinations of blocks in the flow diagrams and block diagrams, can be implemented by computer readable program instructions.

The computer readable program instructions that may implement the systems and methods described in this disclosure may be provided to one or more processors (and/or one or more cores within a processor) of a general purpose computer, special purpose computer, or other programmable apparatus to produce a machine, such that the instructions, which execute via the processor of the computer or other programmable apparatus, create a system for implementing the functions specified in the flow diagrams and block diagrams in the present disclosure. These computer readable program instructions may also be stored in a computer readable storage medium that can direct a computer, a programmable apparatus, and/or other devices to function in a particular manner, such that the computer readable storage medium having stored instructions is an article of manufacture including instructions which implement aspects of the functions specified in the flow diagrams and block diagrams in the present disclosure.

The computer readable program instructions may also be loaded onto a computer, other programmable apparatus, or other device to cause a series of operational steps to be performed on the computer, other programmable apparatus or other device to produce a computer implemented process, such that the instructions which execute on the computer, other programmable apparatus, or other device implement the functions specified in the flow diagrams and block diagrams in the present disclosure.

FIG. 5 is a functional block diagram illustrating a networked system 800 of one or more networked computers and servers. In an embodiment, the hardware and software environment illustrated in FIG. 5 may provide an exemplary platform for implementation of the software and/or methods according to the present disclosure.

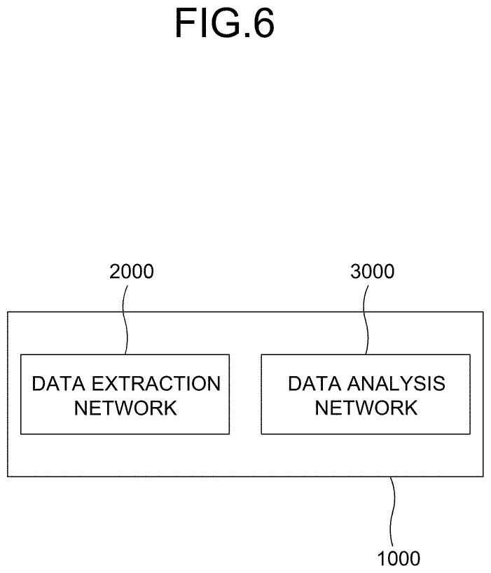

Referring to FIG. 6, a networked system 800 may include, but is not limited to, computer 805, network 810, remote computer 815, web server 820, cloud storage server 825 and computer server 830. In some embodiments, multiple instances of one or more of the functional blocks illustrated in FIG. 5 may be employed.

Additional detail of computer 805 is shown in FIG. 5. The functional blocks illustrated within computer 805 are provided only to establish exemplary functionality and are not intended to be exhaustive. And while details are not provided for remote computer 815, web server 820, cloud storage server 825 and computer server 830, these other computers and devices may include similar functionality to that shown for computer 805.

Computer 805 may be a personal computer (PC), a desktop computer, laptop computer, tablet computer, netbook computer, a personal digital assistant (PDA), a smart phone, or any other programmable electronic device capable of communicating with other devices on network 810.

Computer 805 may include processor 835, bus 837, memory 840, non-volatile storage 845, network interface 850, peripheral interface 855 and display interface 865. Each of these functions may be implemented, in some embodiments, as individual electronic subsystems (integrated circuit chip or combination of chips and associated devices), or, in other embodiments, some combination of functions may be implemented on a single chip (sometimes called a system on chip or SoC).

Processor 835 may be one or more single or multi-chip microprocessors, such as those designed and/or manufactured by Intel Corporation, Advanced Micro Devices, Inc. (AMD), Arm Holdings (Arm), Apple Computer, etc. Examples of microprocessors include Celeron, Pentium, Core i3, Core i5 and Core i7 from Intel Corporation; Opteron, Phenom, Athlon, Turion and Ryzen from AMD; and Cortex-A, Cortex-R and Cortex-M from Arm.

Bus 837 may be a proprietary or industry standard high-speed parallel or serial peripheral interconnect bus, such as ISA, PCI, PCI Express (PCI-e), AGP, and the like.
Memory 840 and non-volatile storage 845 may be computer-readable storage media. Memory 840 may include any suitable volatile storage devices such as Dynamic Random Access Memory (DRAM) and Static Random Access Memory (SRAM). Non-volatile storage 845 may include one or more of the following: flexible disk, hard disk, solid-state drive (SSD), read-only memory (ROM), erasable programmable read-only memory (EPROM or Flash), compact disc (CD or CD-ROM), digital versatile disk (DVD) and memory card or stick.

Program 848 may be a collection of machine readable instructions and/or data that is stored in non-volatile storage 845 and is used to create, manage and control certain software functions that are discussed in detail elsewhere in the present disclosure and illustrated in the drawings. In some embodiments, memory 840 may be considerably faster than non-volatile storage 845. In such embodiments, program 848 may be transferred from non-volatile storage 845 to memory 840 prior to execution by processor 835.

Computer 805 may be capable of communicating and interacting with other computers via network 810 through network interface 850. Network 810 may be, for example, a local area network (LAN), a wide area network (WAN) such as the Internet, or a combination of the two, and may include wired, wireless, or fiber optic connections. In general, network 810 can be any combination of connections and protocols that support communications between two or more computers and related devices.

Peripheral interface 855 may allow for input and output of data with other devices that may be connected locally with computer 805. For example, peripheral interface 855 may provide a connection to external devices 860. External devices 860 may include devices such as a keyboard, a mouse, a keypad, a touch screen, and/or other suitable input devices. External devices 860 may also include portable computer-readable storage media such as, for example, thumb drives, portable optical or magnetic disks, and memory cards. Software and data used to practice embodiments of the present disclosure, for example, program 848, may be stored on such portable computer-readable storage media. In such embodiments, software may be loaded onto non-volatile storage 845 or, alternatively, directly into memory 840 via peripheral interface 855. Peripheral interface 855 may use an industry standard connection, such as RS-232 or Universal Serial Bus (USB), to connect with external devices 860.

Display interface 865 may connect computer 805 to display 870. Display 870 may be used, in some embodiments, to present a command line or graphical user interface to a user of computer 805. Display interface 865 may connect to display 870 using one or more proprietary or industry standard connections, such as VGA, DVI, DisplayPort and HDMI.

As described above, network interface 850, provides for communications with other computing and storage systems or devices external to computer 805. Software programs and data discussed herein may be downloaded from, for example, remote computer 815, web server 820, cloud storage server 825 and computer server 830 to non-volatile storage 845 through network interface 850 and network 810. Furthermore, the systems and methods described in this disclosure may be executed by one or more computers connected to computer 805 through network interface 850 and network 810. For example, in some embodiments the systems and methods described in this disclosure may be executed by remote computer 815, computer server 830, or a combination of the interconnected computers on network 810.

Data, datasets and/or databases employed in embodiments of the systems and methods described in this disclosure may be stored and or downloaded from remote computer 815, web server 820, cloud storage server 825 and computer server 830.

In a non-limiting example, a process is described about how a learned model is trained, according to the present teachings. The example will be in the context of a vehicle external environment estimation circuitry (e.g., a trained model saved in a memory and applied by a computer). However, other aspects of the trained model for object detection/avoidance, route generation, controlling steering, braking, etc., are implemented via similar processes to acquire the learned models used in the components of the arithmetic unit 110. Hereinafter, as part of a process for determining how a candidate route generation unit 112 calculates a route in the presence of an obstacle (a person). In this example, the obstacle is a person that has been captured by a forward looking camera from the vehicle 1. The model is hosted in a single information processing unit (or single information processing circuitry).

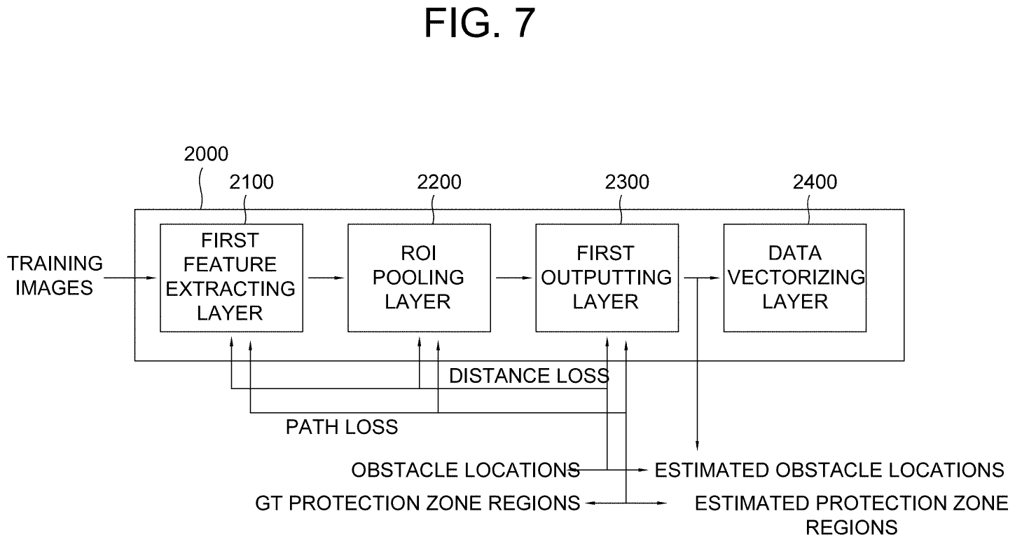

First, by referring to FIG. 6, a configuration of the computing device 1000 will be explained. The computing device 1000 may include a data extraction network 2000 and a data analysis network 3000. Further, to be illustrated in FIG. 7, the data extraction network 2000 may include at least one first feature extracting layer 2100, at least one Region-Of-Interest(ROI) pooling layer 2200, at least one first outputting layer 2300 and at least one data vectorizing layer 2400. And, the data analysis network 3000 may include at least one second feature extracting layer 3100 and at least one second outputting layer 3200.

Below, an aspect of calculating a route within a free space that surrounds the obstacle will be explained in the context of training a learned model. Moreover, the specific aspect is to learn a model to detect obstacles. To begin with, a first aspect of the learning of a learned model according to the present disclosure will be presented.

First, the computing device 1000 may acquire at least one subject image that includes a free space about the vehicle 1. By referring to FIG. 5, the subject image may correspond to a scene of a highway, photographed from a vehicle 1.

After the subject image is acquired, in order to generate a source vector to be inputted to the data analysis network 3000, the computing device 1000 may instruct the data extraction network 2000 to generate the source vector including (i) an apparent distance, which is a distance from a front of vehicle 1 to an obstacle, and (ii) an apparent size, which is a size of the free space

In order to generate the source vector, the computing device 1000 may instruct at least part of the data extraction network 2000 to detect the obstacle and free space.

Specifically, the computing device 1000 may instruct the first feature extracting layer 2100 to apply at least one first convolutional operation to the subject image, to thereby generate at least one subject feature map. Thereafter, the computing device 1000 may instruct the ROI pooling layer 2200 to generate one or more ROI-Pooled feature maps by pooling regions on the subject feature map, corresponding to ROIs on the subject image which have been acquired from a Region Proposal Network (RPN) interworking with the data extraction network 2000. And, the computing device 1000 may instruct the first outputting layer 2300 to generate at least one estimated obstacle location and one estimated free space. That is, the first outputting layer 2300 may perform a classification and a regression on the subject image, by applying at least one first Fully-Connected (FC) operation to the ROI-Pooled feature maps, to generate each of the estimated obstacle location and free space, including information on coordinates of each of bounding boxes. Herein, the bounding boxes may include the obstacle and a free space around the obstacle.

After such detecting processes are completed, by using the estimated obstacle location and the estimated free space, the computing device 1000 may instruct the data vectorizing layer 2400 to subtract a y-axis coordinate (distance in this case) of an upper bound of the obstacle from a y-axis coordinate of the closer boundary of the free space to generate the apparent distance to the vehicle 1, and multiply a distance of the free space region and a horizontal width of the free space region to generate the apparent size of the free space.

After the apparent distance and the apparent size are acquired, the computing device 1000 may instruct the data vectorizing layer 2400 to generate at least one source vector including the apparent distance and the apparent size as its at least part of components.

Then, the computing device 1000 may instruct the data analysis network 3000 to calculate an estimated actual free space by using the source vector. Herein, the second feature extracting layer 3100 of the data analysis network 3000 may apply second convolutional operation to the source vector to generate at least one source feature map, and the second outputting layer 3200 of the data analysis network 3000 may perform a regression, by applying at least one FC operation to the source feature map, to thereby calculate the estimated free space.

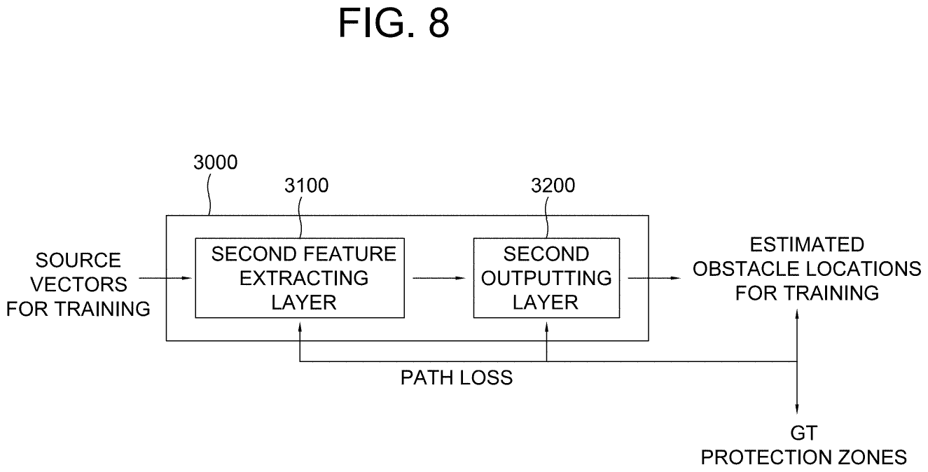

As shown above, the computing device 1000 may include two neural networks, i.e., the data extraction network 2000 and the data analysis network 3000. The two neural networks should be trained to perform the processes properly, and thus below it is described how to train the two neural networks by referring to FIG. 7 and FIG. 8.

First, by referring to FIG. 8, the data extraction network 2000 may have been trained by using (i) a plurality of training images corresponding to scenes of subject roadway conditions for training, photographed from fronts of the subject vehicles for training, including images of their corresponding projected free spaces (free spaces superimposed around an obstacle) for training and images of their corresponding grounds for training, and (ii) a plurality of their corresponding to actual observed obstacle locations and actual observed free space regions. The free space regions do not occur naturally, but are previously superimposed about the vehicle 1 via another process, perhaps a bounding box by the camera. More specifically, the data extraction network 2000 may have applied aforementioned operations to the training images, and have generated their corresponding estimated obstacle location and estimated free space regions. Then, (i) each of obstacle pairs of each of the estimated obstacle locations and each of their corresponding actual observed obstacle locations and (ii) each of obstacle pairs of each of the estimated free space locations associated with the obstacles and each of the actual observed free space locations may have been referred to, in order to generate at least one vehicle path loss and at least one distance, by using any of loss generating algorithms, e.g., a smooth-L1 loss algorithm and a cross-entropy loss algorithm. Thereafter, by referring to the distance loss and the path loss, backpropagation may have been performed to learn at least part of parameters of the data extraction network 2000. Parameters of the RPN can be trained also, but a usage of the RPN is a well-known prior art, thus further explanation is omitted.

Herein, the data vectorizing layer 2400 may have been implemented by using a rule-based algorithm, not a neural network algorithm. In this case, the data vectorizing layer 2400 may not need to be trained, and may just be able to perform properly by using its settings inputted by a manager.

As an example, the first feature extracting layer 2100, the ROI pooling layer 2200 and the first outputting layer 2300 may be acquired by applying a transfer learning, which is a well-known prior art, to an existing object detection network such as VGG or ResNet, etc.

Second, by referring to FIG. 8, the data analysis network 3000 may have been trained by using (i) a plurality of source vectors for training, including apparent distances for training and apparent sizes for training as their components, and (ii) a plurality of their corresponding actual observed free space regions. More specifically, the data analysis network 3000 may have applied aforementioned operations to the source vectors for training, to thereby calculate their corresponding estimated free space regions for training. Then each of distance pairs of each of the estimated free space regions and each of their corresponding actual observed free space regions may have been referred to, in order to generate at least one distance loss, by using said any of loss algorithms. Thereafter, by referring to the distance loss, backpropagation can be performed to learn at least part of parameters of the data analysis network 3000.

After performing such training processes, the computing device 1000 can properly calculate the estimated free space by using the subject image including the scene photographed from the front of the subject roadway.

Hereafter, another embodiment will be presented. A second embodiment is similar to the first embodiment, but different from the first embodiment in that the source vector thereof further includes a tilt angle, which is an angle between an optical axis of a camera which has been used for photographing the subject image (e.g., the subject obstacle) and a distance to the obstacle. Also, in order to calculate the tilt angle to be included in the source vector, the data extraction network of the second embodiment may be slightly different from that of the first one. In order to use the second embodiment, it should be assumed that information on a principal point and focal lengths of the camera are provided.

Specifically, in the second embodiment, the data extraction network 2000 may have been trained to further detect lines of a road in the subject image, to thereby detect at least one vanishing point of the subject image. Herein, the lines of the road may denote lines representing boundaries of the road located on the obstacle in the subject image, and the vanishing point may denote where extended lines generated by extending the lines of the road, which are parallel in the real world, are gathered. As an example, through processes performed by the first feature extracting layer 2100, the ROI pooling layer 220 and the first outputting layer 2300, the lines of the road may be detected.

After the lines of the road are detected, the data vectorizing layer 240 may find at least one point where the most extended lines are gathered, and determine it as the vanishing point. Thereafter, the data vectorizing layer 2400 may calculate the tilt angle by referring to information on the vanishing point, the principal point and the focal lengths of the camera by using a following formula:

θₜᵢₗₜ=a tan 2(vy−cy,fy)

In the formula, vy may denote a y-axis (distance direction) coordinate of the vanishing point, cy may denote ay-axis coordinate of the principal point, and fy may denote a y-axis focal length. Using such formula to calculate the tilt angle is a well-known prior art, thus more specific explanation is omitted.

After the tilt angle is calculated, the data vectorizing layer 2400 may set the tilt angle as a component of the source vector, and the data analysis network 3000 may use such source vector to calculate the estimated free space. In this case, the data analysis network 3000 may have been trained by using the source vectors for training additionally including tilt angles for training.

For a third embodiment which is mostly similar to the first one, some information acquired from a subject obstacle database storing information on subject obstacles, including the subject obstacle, can be used for generating the source vector. That is, the computing device 1000 may acquire structure information on a structure of the subject vehicle, e.g., 4 doors, vehicle base length of a certain number of feet, from the subject vehicle DB. Or, the computing device 1000 may acquire topography information on a topography of a region around the subject vehicle, e.g., hill, flat, bridge, etc., from location information for the particular roadway. Herein, at least one of the structure information and the topography information can be added to the source vector by the data vectorizing layer 2400, and the data analysis network 3000, which has been trained by using the source vectors for training additionally including corresponding information, i.e., at least one of the structure information and the topography information, may use such source vector to calculate the estimated free space.

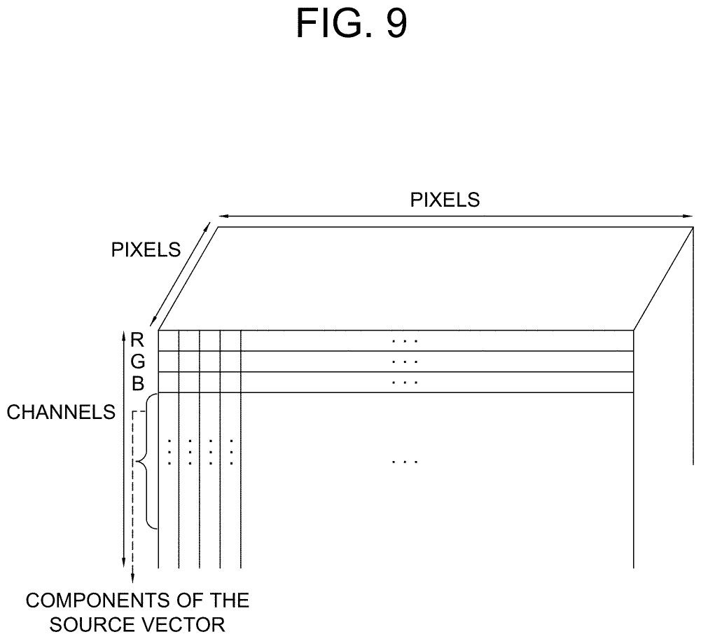

As a fourth embodiment, the source vector, generated by using any of the first to the third embodiments, can be concatenated channel-wise to the subject image or its corresponding subject segmented feature map, which has been generated by applying an image segmentation operation thereto, to thereby generate a concatenated source feature map, and the data analysis network 3000 may use the concatenated source feature map to calculate the estimated free space. An example configuration of the concatenated source feature map may be shown in FIG. 9. In this case, the data analysis network 3000 may have been trained by using a plurality of concatenated source feature maps for training including the source vectors for training, other than using only the source vectors for training. By using the fourth embodiment, much more information can be inputted to processes of calculating the estimated free space, thus it can be more accurate. Herein, if the subject image is used directly for generating the concatenated source feature map, it may require too much computing resources, thus the subject segmented feature map may be used for reducing a usage of the computing resources.

Descriptions above are explained under an assumption that the subject image has been photographed from the back of the subject vehicle, however, embodiments stated above may be adjusted to be applied to the subject image photographed from other sides of the subject vehicle. And such adjustment will be easy for a person in the art, referring to the descriptions.

The above described deep learning process for defining free spaces around obstacles, may be used in a similar fashion for developing other learned models, such as for estimating an internal or external environment within the vehicle, calculating a route etc. as discussed herein.

The embodiment described above is merely an example in nature, and the scope of the present disclosure should not be interpreted in a limited manner. The scope of the present disclosure is defined by the appended claims, and all variations and changes belonging to a range equivalent to the range of the claims are within the scope of the present disclosure.

### INDUSTRIAL APPLICABILITY

The present disclosure is usable as a motor vehicle cruise controller to control traveling of a motor vehicle.

### DESCRIPTION OF REFERENCE CHARACTERS

1 Motor Vehicle
100 Motor Vehicle Cruise Control System
110 Arithmetic Unit
111 Vehicle Exterior Environment Recognition Unit
112 Route Generation Unit (Route Setting Unit)
113 Vehicle Behavior Estimation Unit (Route Setting Unit)
114 Occupant Behavior Estimation Unit (Route Setting Unit)
115 Route Determination Unit (Route Setting Unit)
116 Vehicle Motion Determination Unit (Target Motion determination unit)
117 Driving Force Calculation Unit (Physical Amount Calculation Unit)
118 Braking Force Calculation Unit (Physical Amount Calculation Unit)
119 Steering Amount Calculation Unit (Physical Amount Calculation Unit)
129 Steering Controller
200 Powertrain ECU (Driving Microcomputer)
300 Brake Microcomputer (Braking Microcomputer)
500 Steering Device Driver (Steering Device)

1. An arithmetic unit for controlling traveling of a motor vehicle, comprising:
circuitry configured to
recognize a vehicle exterior environment based on an output from a sensor configured to acquire information of the vehicle exterior environment;
set a route to be traveled by the motor vehicle, in accordance with the vehicle exterior environment recognized;
determine a target motion of the motor vehicle to follow the route set;
calculate a first target physical amount corresponding to a steering amount for achieving the target motion;
generate a control signal for controlling a steering device configured to produce a steering amount based on the first target physical amount calculated and directly output the control signal to the steering device,
calculate a second target physical amount corresponding to a driving force for achieving the target motion and in accordance with the first target physical amount, and output the second target physical to a first microcomputer configured to control a driving device configured to produce a driving force; and
calculate a third target physical amount corresponding to a braking force for achieving the target motion and in accordance with the first target physical amount, and output the third target physical amount calculated to a second microcomputer configured to control a braking device configured to produce a braking force.

2. A cruise control system for controlling traveling of a motor vehicle, the system comprising:
the arithmetic unit of claim 1;
the first microcomputer; and
the second microcomputer, wherein
the first microcomputer and the second microcomputer being configured to be capable of communicating with each other and to share information for use to perform control that allows the driving device and the braking device to coordinate.

3. A method of controlling traveling of a motor vehicle, the method comprising:
recognizing a vehicle exterior environment;
setting a route to be traveled by the vehicle in accordance with the vehicle exterior environment recognized;
determining a target motion of the vehicle to follow the route;
calculating a steering amount for achieving the target motion;
generating a control signal for controlling a steering device based on the steering amount;
directly outputting the control signal to the steering device;
calculating a driving force for achieving the target motion and in accordance with the steering amount;
outputting the drive force to a first microcomputer controlling a driving device;
calculating a braking force for achieving the target motion and in accordance with the steering amount; and
outputting the braking force to a second microcomputer controlling a braking device.

4. A non-transitory computer readable medium having instructions stored therein that once executed by a processor cause the processor to execute a vehicle travel control method, the method comprising:
recognizing a vehicle exterior environment;
setting a route to be traveled by the vehicle in accordance with the vehicle exterior environment recognized;
determining a target motion of the vehicle to follow the route;
calculating a steering amount for achieving the target motion;
generating a control signal for controlling a steering device based on the steering amount;
directly outputting the control signal to the steering device;
calculating a driving force for achieving the target motion and in accordance with the steering amount;
outputting the drive force to a first microcomputer controlling a driving device;
calculating a braking force for achieving the target motion and in accordance with the steering amount; and
outputting the braking force to a second microcomputer controlling a braking device.
